(19) United States
(12) Patent Application Publication
(10) Pub. No.: US 2026/0250859 A1
(43) Pub. Date: Aug. 27, 2026

(54) CONTROL OF AN ELECTROLYSIS SYSTEM FOR PRODUCING HYDROGEN AND OXYGEN BY ELECTROLYSING WATER

(71) Applicant: Siemens Energy Global GmbH & Co. KG, München (DE)

(72) Inventors: Thomas Achter, Forchheim (DE); Fisnik Loku, Nürnberg (DE)

(21) Appl. No.: 19/163,041

(22) PCT Filed: Jul. 8, 2024
(86) PCT No.: PCT/EP2024/069156

§ 371 Date: Sep. 8, 2025

(30) Foreign Application Priority Data
Jul. 31, 2023 (DE) 10 2023 207 312.9

(51) Int. Cl. C25B 9/65; C25B 1/04; C25B 9/70; C25B 15/02; H02M 7/217

(52) U.S. Cl. CPC C25B 9/65; C25B 1/04; C25B 9/70; C25B 15/02; H02M 7/217

(57) ABSTRACT

An electrolysis system includes a plurality of electrolysis devices connected to a power supply line, the electrolysis devices having an electrical energy supply unit and an electrolysis module coupled to the power supply unit. The energy supply units of the electrolysis devices include a transformer and a rectifier unit. The transformer has a primary winding and a secondary winding connected to an AC voltage side of the rectifier unit. The primary winding of the transformer of at least a first of the electrolysis devices is configured to be adjustable in stages, and the rectifier unit of that electrolysis device is configured to be operated in an uncontrolled manner. The rectifier unit of the energy supply unit of at least a second of the electrolysis devices is configured to be operated in a controlled manner depending on the electrical energy that can be provided by the energy source.

The invention relates to an electrolysis system for producing hydrogen and oxygen by electrolyzing water, which system has a plurality of electrolysis devices which are connected to an electrical energy supply line which is energized by means of an alternating electric voltage, for the supply thereof with electrical energy for a regulation electrolysis operation via the electrical energy supply line, wherein the energy supply line is configured for electrically coupling an electrical energy source, wherein the electrolysis devices respectively comprise an energy supply unit and at least one electrolysis module which is electrically coupled to the energy supply unit, wherein the at least one electrolysis module comprises a plurality of electrolysis cells which, at least in part, are electrically series-connected or parallel-connected, wherein the energy supply unit of the electrolysis devices respectively comprises at least one transformer and at least one rectifier unit, wherein the at least one transformer comprises a primary winding which is electrically coupled to the energy supply line and a secondary winding which is connected to an AC voltage side of the at least one rectifier unit, wherein a DC voltage side of the at least one rectifier unit is electrically connected to the at least one electrolysis module. The invention further relates to a method for producing hydrogen and oxygen by an electrolysis of water by means of an electrolysis system which comprises a plurality of electrolysis devices, wherein the electrolysis devices respectively comprise an energy supply unit and at least one electrolysis module which is electrically coupled to the energy supply unit, wherein the at least one electrolysis module comprises a plurality of electrolysis cells which, at least in part, are electrically series-connected or parallel-connected, wherein the electrolysis devices are supplied with electrical energy for a regulation electrolysis operation via an electrical energy supply line which is energized by means of an alternating electric voltage, wherein the energy supply line is electrically coupled to an electrical energy source, wherein the energy supply units of the electrolysis devices respectively comprise at least one transformer and at least one rectifier unit, wherein the at least one transformer comprises a primary winding which is electrically coupled to the energy supply line and a secondary winding which is connected to an AC voltage side of the at least one rectifier unit, wherein a DC voltage side of the at least one rectifier unit is electrically connected to the at least one electrolysis module.

Generic electrolysis systems, electrolysis devices and electrolysis methods are comprehensively known from the prior art, such that any separate documentary evidence thereof is not required. Generic electrolysis technologies employ a cascading demand control strategy for controlling the capacity of a respective electrolysis device of the electrolysis system. For an individual electrolysis device, or a small number thereof, it is necessary for a capacity setting to be executed in accordance with electrical energy which is available from the electric power source for generating hydrogen and oxygen. In the case of large electrolysis systems, for example having more than ten electrolysis devices, on the grounds of individual control functions and corrective power factor adjustment, together with the filtering of harmonics for the fulfilment of grid system operator requirements, this capacity setting represents a major challenge.

On the grounds of the high capacity demand of electrolysis systems, which is associated with a corresponding current stress, thyristor-based rectifier units are customarily employed for the achievement of the requisite DC current, for example within a range of approximately 7 kA to approximately 10 kA. On the grounds of the high efficiency and high reliability associated with high-current applications, the employment thereof is expected, even in large electrolysis systems. At present, high current demands are a primary reason for the existing preclusion of the employment of voltage-based converters, for example employing transistor-based DC/DC converters.

However, thyristor-based rectifier units, with respect to a current stress of the energy source, assume a significant disadvantage with respect to harmonics. In general, this dictates the employment of additional components, for example active and/or passive filters, together with power factor compensation units, in order to enable the fulfilment of energy source-side requirements, particularly with respect to reactive power demand in an AC power grid of the energy source. However, this results in correspondingly high additional costs.

Moreover, thyristor-based rectifier units generally require three control devices, and a central control device for the control of stepping in a step-controlled primary winding of the transformer, together with an additional control device for controlling active power and for supplying a corresponding control signal for a DC current control device, which device is employed for controlling the DC current, in accordance with the above-mentioned control signal, by the control of an ignition angle for the thyristors of the thyristor-based rectifier unit, and which comprises a phase-locked-loop (PLL) controller, in order to enable an adjustment of the ignition angle of thyristors with respect to an AC voltage which is applied to the AC side of the rectifier unit.

These control devices influence harmonics and the power factor. The central control device, the additional control device and the DC current control device are required for each of the electrolysis devices. A high degree of technical effort is also generated as a result.

The fundamental object of the invention is the reduction of technical effort associated with the elimination of harmonics and of an unfavorable power factor in large electrolysis systems.

By way of a solution according to the invention, electrolysis systems and methods according to the independent claims are proposed.

Advantageous further developments proceed from the features of the dependent claims.

With respect to an electrolysis system of the generic type, according to a first aspect of the invention, in particular, it is proposed that the primary winding of the at least one transformer of at least a first of the electrolysis devices is designed for step-wise adjustment, and that the at least one rectifier unit of the energy supply unit of this electrolysis device is designed to be operated in an uncontrolled manner, wherein the at least one rectifier unit of the energy supply unit of at least a second of the electrolysis devices is designed to be operated in a controlled manner, according to the electrical energy which can be supplied by the energy source.

With respect to a generic electrolysis system, according to a second aspect of the invention, in particular, it is proposed that the electrolysis system comprises an energy storage unit which is connected to the energy supply line, for the reversible storage of electrical energy, wherein the energy storage unit is designed for the continuous storage and release of electrical energy in a controlled manner, wherein the primary winding of the at least one transformer of at least a first of the electrolysis devices is adjustable in a step-wise manner, and the at least one rectifier unit of the energy supply unit of this electrolysis device is designed to be operated in an uncontrolled manner.

With respect to a generic method, according to the first aspect of the invention, in particular, it is proposed that the primary winding of the at least one transformer of at least a first of the electrolysis devices is designed for step-wise adjustment, and that the at least one rectifier unit of the energy supply unit of this electrolysis device is operated in an uncontrolled manner, wherein the at least one rectifier unit of the energy supply unit of at least a second of the electrolysis devices is designed to be operated in a controlled manner, in accordance with the electrical energy which can be supplied by the energy source.

With respect to a generic method, according to a second aspect of the invention, in particular, it is proposed that an energy storage unit which is designed for the reversible storage of electrical energy is connected to the energy supply line, which energy storage unit executes the continuous storage and release of electrical energy in a controlled manner, wherein the primary winding of the at least one transformer of at least a first of the electrolysis devices is adjustable in a step-wise manner, and the at least one rectifier unit of the energy supply unit of this electrolysis device is operated in an uncontrolled manner.

The invention is based, inter alia, upon the concept whereby the capacity of the electrolysis system can be adjusted in accordance with the available electrical capacity of the energy source. To this end, it is proposed that, in the at least one first electrolysis device, the at least one transformer, with respect to the primary winding thereof, can be adjusted in a step-wise manner, as a result of which the secondary voltage of the secondary winding can be correspondingly varied such that, according to the respective AC voltage set in a respective step, the capacity can be adjusted. In this electrolysis device, it is further provided that the at least one rectifier unit is configured to be operated in an uncontrolled manner. This means that, in this at least one electrolysis device, variation of capacity is exclusively executed by the setting of a respective step of the primary winding. In this case, the provision of a capacity adjustment by means of the at least one rectifier unit is not required. As a result, this at least one rectifier unit can be configured with a comparatively cost-effective design. In particular no controller is required for this purpose.

At the same time, at least one second electrolysis device is provided, wherein the at least one rectifier unit can be operated in a controlled manner, according to the electrical capacity which can be supplied by the energy source. Preferably, in the at least one first electrolysis device, the step setting of the primary winding of the at least one transformer is also controlled according to the electrical energy which can be supplied by the energy source. To this end, a superordinate controller, or a control device or control unit, can supply a corresponding control signal, by means of which the desired control functionalities can be achieved. The control signals can differ for the at least one first electrolysis device and for the at least one second electrolysis device.

This structure, on the one hand, for the at least one first electrolysis device, enables the at least one rectifier unit to be embodied, for example, by means of diodes, such that the uncontrolled rectifier unit can be embodied in a simple manner. The rectifier unit can be configured in a manner which is adapted to the AC voltage which is supplied by way of the secondary voltage. The rectifier unit is preferably configured in the manner of a bridge circuit. The rectifier unit is moreover configured in a manner which is adapted to the AC voltage which is supplied by the energy source. It should be observed that the AC voltage can be a multi-phase AC voltage and, in particular, can comprise three phases. However, the invention is not limited to a specific number of phases. The transformers and the rectifier units are configured in a manner which is adapted to the number of phases of the AC voltage.

For example, the AC voltage can be supplied by the energy source in the form of a three-phase AC voltage and, in consequence, can also be supplied by the transformer, as a result of which the rectifier unit can be exemplarily configured as a six-pulse bridge circuit, as a 12-pulse bridge circuit, as a 24-pulse bridge circuit, or similar. For the at least one first electrolysis device, in consequence, only a comparatively limited technical control effort is required for setting the capacity, namely, only to the extent that a setting of a corresponding step on the primary winding is required by means of an actuator of the electrolysis device, in accordance with the control signal. The actuator can comprise, for example, one or more switching elements, by means of which one or more taps of the primary winding can be selectively coupled, in order to enable the setting of the desired step of the step-wise adjustable primary winding.

In the at least one second electrolysis device, however, it is provided that the at least one rectifier unit is a controlled rectifier unit. This unit can be configured, for example, in a similar manner to the at least one rectifier unit of the first electrolysis device wherein, however, the diodes can be replaced by transistors. A corresponding thyristor controller is thus provided for the thyristors, which controller, by means of phase control, enables the execution of a corresponding capacity control. At the same time, in the at least one transformer, it is not absolutely necessary for a stepped primary winding to be provided. In essence, however, the at least one transformer of the at least one second electrolysis device can be configured and adjusted in an identical manner to the at least one transformer of the at least one first electrolysis device.

From this structure, it proceeds that, overall, technical control effort for the electrolysis system can be significantly reduced. Depending upon the AC voltage and the capacity take-up, and the electrical properties of electrolysis devices, an AC current is set on the energy source side, which AC current, in the at least one first electrolysis device, assumes a very small, if not negligible harmonic component with respect to the AC current. It can also be achieved that the power factor of the at least one first electrolysis device is as high as possible, and is preferably close to 1, such that technical effort for power factor correction, and for the management of harmonics, can be substantially reduced. Impacts upon the energy source, with respect to requirements governing system perturbations, can thus be very limited. On the grounds that it is only necessary for a corresponding filtering or corrective measure to be provided for the at least one second electrolysis device, overall, technical effort for the reduction of system perturbations can also be restricted to a very low level, vis-à-vis the prior art. The invention therefore enables a reduction of technical effort, not only for the electrolysis system as a whole, but also of control, at the same time.

Essentially, the same effect can also be achieved according to the second aspect wherein, in place of or additionally to the at least one second electrolysis device, an energy storage unit is connected to the energy supply line, which unit is employed for the reversible storage of electrical energy. The energy storage unit is configured for the storage and release of electrical energy in a continuously controllable manner. This can be achieved, for example, wherein the energy storage unit comprises an appropriate electrical energy store, such as one or more capacitors, one or more inductances and/or similar. The at least one electrical energy store can be connected to the energy supply line, in a controlled manner, by means of an energy transformer unit or an energy converter unit such that, in accordance with a control signal which, for example, can also be supplied by the control unit, electrical energy can be injected into the energy supply line, or electrical energy can be extracted from the energy supply line. As a result, for example, it is possible for a power factor correction to be executed and/or for harmonics to be compensated. The energy converter provided for this purpose can be embodied, for example, by means of transistors or fast-switching thyristors. By means of the energy storage unit, in essence, a comparable electrical effect is achieved with respect to the electrical energy source as that which can be achieved by means of the at least one second electrolysis device. In practice, if electrical capacity is available from the electrical energy source to a degree which exceeds the capacity take-up of the at least one first electrolysis device in a stipulated first step, but is lower than the capacity associated with the next highest step of the primary winding of the at least one transformer, this capacity differential can be offset by means of the energy storage unit.

By means of the energy storage unit, a take-up of electrical capacity according to the step setting of the primary winding of the at least one first electrolysis device can be executed for a definable time period.

Immediately the at least one energy storage unit has executed the take-up of a quantity of energy of a corresponding magnitude, in the at least one first electrolysis device, a setting of the next highest step of the primary winding of the at least one transformer can be engaged, and the storage unit can release energy thus taken up to the at least one first electrolysis device, via the energy supply line. On the grounds that, in this manner, an essentially continuous capacity transition is enabled, system perturbations on the electrical energy source can be substantially reduced, if not virtually entirely eliminated. At the same time, a high actuator speed is enabled, even at high capacities.

Overall, from the invention according to the first and the second aspect, it proceeds that particularly large electrolysis systems having a plurality of electrolysis devices can be operated in a highly efficient manner, with a comparatively low level of system perturbations. At the same time, technical effort be reduced, and the option for the employment of diode-based rectifier units also enables the improvement of efficiency.

The at least one transformer of the electrolysis devices is preferably configured in a manner which is adapted to the AC voltage supplied, and to the DC voltage required for the purposes of electrolysis. In the case of a single-phase AC voltage, the transformer is preferably configured as a single-phase transformer. In the case of a multi-phase AC voltage, for example, in particular a three-phase AC voltage, the transformer is appropriately configured for the number of phases. The at least one transformer, for example in the case of a three-phase AC voltage, can be configured with a delta-connected circuit on the primary side. On the secondary side, it can be provided that the transformer comprises a delta-connected circuit or a star-connected circuit. However, the invention is not limited to the employment of transformer circuits of these types.

An electrolysis device can assume an electrical capacity take-up, for example, of 17 MW. For the stepping of the primary winding of the at least one transformer, it can be provided that two respectively sequential steps bring about a stipulated or definable capacity differential. Preferably, the capacity differential between sequential steps is essentially equal. According to alternative configurations, however, a divergence herefrom is also possible.

A design capacity of the energy supply unit of the at least one second electrolysis device or of the energy storage unit preferably corresponds to at least the above-mentioned capacity differential between two sequential steps of the primary winding of the transformer of the at least one first electrolysis device.

In particular, it is proposed that a design capacity of the energy storage unit, with respect to the storage and release of electrical energy, is greater than a capacity differential of two sequential steps of the step-wise adjustable primary winding during the regulation operation of the at least one first electrolysis device. It is thus possible, in the event of a stipulated step setting of the primary winding of the at least one first electrolysis device, to enable the take-up of an available surplus capacity of the electrical energy source or, in the converse case, to release a corresponding capacity output. As the energy storage unit, with respect to the storage of electrical energy and the release of electrical energy, is adjustable in an essentially continuous manner, an available capacity of the electrical energy source can thus be essentially utilized in full, in the event that this capacity does not correspond exactly to the electrical capacity take-up of the at least one first electrolysis device associated with a specific step setting.

It is further proposed that the at least one transformer for the step-wise adjustment of the primary winding comprises a tap changer having at least five steps, and preferably at least nine steps. Naturally, the tap changer can also comprise a significantly greater number of steps. The greater the number of steps selected, the finer the control capability with respect to the at least one first electrolysis device. Under certain circumstances, this enables the design capacity of the at least one second electrolysis device or the energy storage unit to be selected with a correspondingly lower rating. As a result, further advantages are achieved, particularly with respect to system perturbations. This is advantageous, inter alia, in the event of particularly high capacities.

According to a further development, the electrolysis system comprises a control unit which is configured to receive an energy availability signal and, according to the energy availability signal, firstly, to execute the setting of the step of the primary winding of the at least one transformer of the at least one first electrolysis device, and secondly to execute the adjustment of at least the electrical capacity of the at least one second electrolysis device, by means of the rectifier unit thereof, or at least the electrical capacity of the energy storage unit. To this end, the control unit can be communicatively connected to the electrical energy source. If the electrical energy source is an electricity supply grid, for example a public electricity supply grid, it can be provided that the control unit is communicatively connected to a control center of the power supply grid. The control unit can be configured, according to the available electrical capacity, to deliver corresponding control signals for the at least one first and the at least one second electrolysis device and, optionally, for the energy storage unit, such that the desired electrical capacity take-up of the electrolysis system can be achieved. In this manner, a particularly simple and rapid response to changing load conditions with respect to the electrical energy source can be enabled. Notwithstanding the high capacity of the electrolysis system, a stable operation of the electrical energy source can be achieved, particularly in the event that the electrical energy source is an electricity supply grid.

It is further proposed that a sum of the design capacity of the energy storage unit, with respect to the storage and release of electrical energy, and the design capacity of the at least one controllably operable rectifier unit of the energy supply unit of the at least one second electrolysis device is greater than the capacity differential of two sequential steps of the step-wise adjustable primary winding in the regulation operation of the at least one first electrolysis device. This further development, inter alia, particularly addresses a configuration in which the electrolysis system, in addition to the at least one first electrolysis device, also comprises at least one second electrolysis device and an energy storage unit. By means of combined operation, the capacity differential between two sequential steps of the at least one first electrolysis device can be correspondingly divided over the at least one second electrolysis device and the energy storage unit. This enables the technical effort associated with a continuously adjustable capacity to be divided over the at least one second electrolysis device and the electrolysis unit.

Advantages and effects disclosed with respect to electrolysis systems according to the invention also apply, in a corresponding manner, to methods according to the invention, and vice versa. In consequence, features of methods can also be formulated as corresponding features of devices, and vice versa.

For applications and application situations which might potentially arise in conjunction with the method, and which are not explicitly described herein, it can be provided that, according to the method, an output of an error message and/or of a request for the input of user feedback is generated, and/or that a standard setting and/or the setting of a predefined initial state is engaged.

The exemplary embodiments described hereinafter are preferred embodiments of the invention. The features and combinations of features disclosed in the preceding description, together with features and combinations of features which are specified in the following description of exemplary embodiments and/or which are represented in the figures alone, are not only applicable in the respectively indicated combination, but also in other combinations. Embodiments of the invention are thus included, or are considered to be disclosed, which embodiments are not explicitly represented in the FIG. and described, but which proceed and can be derived from the embodiments described by separate combinations of features. Features, functions and/or effects represented in reference to the exemplary embodiments, in their own right, can respectively represent individual features, functions and/or effects of the invention which are to be considered in a mutually independent manner and which, in each case, further develop the invention in a mutually independent manner. Consequently, the exemplary embodiments also include other combinations than those represented in the embodiments described. Moreover, the embodiments described can also be expanded to include further of the above-mentioned features, functions and/or effects of the invention.

In the figures, identical reference symbols identify identical features and functions.

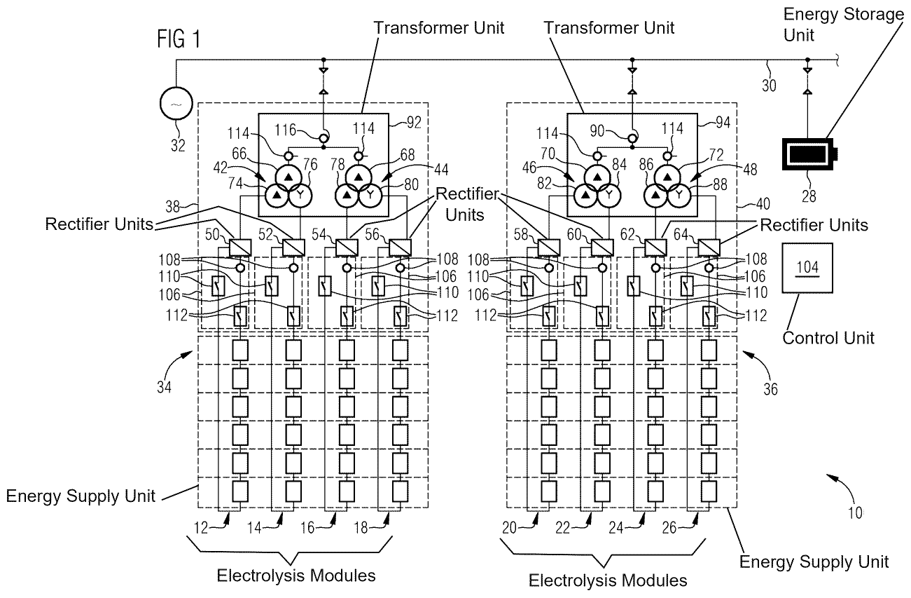

FIG. 1 shows a schematically represented circuit diagram of an electrolysis system having two electrolysis devices and an energy storage unit, which are connected to an energy supply line;

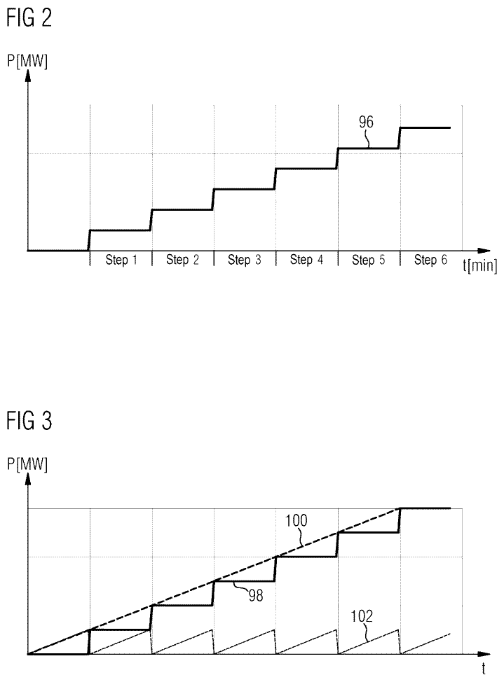

FIG. 2 shows a schematic diagrammatic representation of a step-wise adjustment of a primary winding of a transformer of an energy supply unit of an electrolysis device according to FIG. 1; and

FIG. 3 shows a schematic diagrammatic representation of a capacity adjustment of the electrolysis system according to FIG. 1 to an available capacity of an AC voltage source.

FIG. 1 shows a schematically represented circuit diagram of an electrolysis system 10 which is employed for producing hydrogen and oxygen by an electrolysis of water. To this end, the electrolysis system 10 comprises two electrolysis devices 34, 36 which are connected to an electrical energy supply line 30 which is energized by means of a three-phase alternating electric voltage, for the supply thereof with electrical energy for a regulation electrolysis operation via the electrical energy supply line 30. According to the present configuration, it is provided that the energy supply line 30 is employed for the coupling of a three-phase AC voltage source 32, by way of an electrical energy source. In the present case, the three-phase AC voltage source 32 is a public electricity supply grid. In alternative configurations, naturally, a separate network, or similar, can also be provided. Naturally, the electrolysis system 10 can also comprise more than two electrolysis devices 34, 36. A person specialized in the art will observe that, in essence, the number of electrolysis devices is not relevant to the explanation of the invention. In the present case, the AC voltage grid 32 is configured for three-phase operation.

The electrolysis devices 34, 36 respectively comprise an energy supply unit 38, 40 and a plurality of, in the present case, series-connected electrolysis modules 12, 14, 16, 18, 20, 22, 24, 26 which are connected in series to the respective energy supply unit 38, 40. Thus, for example, six electrolysis modules are 12 are connected in series to the energy supply unit 38. Likewise, six series-connected electrolysis modules 14 are connected to the energy supply unit 38. In the same way, in each case, six electrolysis modules 16 and six electrolysis modules 18 are respectively connected to the energy supply unit 38. The same applies, correspondingly, to the electrolysis device 36, wherein series-connected arrangements of electrolysis modules 20, 22, 24, 26, each of which likewise comprises six series-connected electrolysis modules, are separately connected to the energy supply unit 40.

In the figure, it is not represented that each of the electrolysis modules 12, 14, 16, 18, 20, 22, 24, 26 comprises a stipulated number of electrolysis cells which are electrically interconnected, in a stipulated manner, in a matrix circuit. Depending upon construction, however, it can also be provided that electrolysis cells within any one of the respective electrolysis modules 12 to 26 are only parallel-connected, or are only series-connected. In the present case, it is provided the electrolysis cells, and the electrolysis modules 12 to 26 which are formed therefrom, assume an essentially identical design. In the figure, it is likewise not represented that each of the electrolysis cells or each of the electrolysis modules comprises a respective port for water which is to be electrolyzed, and respective ports for hydrogen or oxygen generated by electrolysis. However, the detailed layout of a respective electrolysis cell or of any one of the respective electrolysis modules 12 to 26 is not relevant to the invention, on which grounds, in the present case, any further elaborations with respect hereto are omitted.

In the present configuration according to FIG. 1, it is further provided that the electrolysis system 10 comprises an energy storage unit 28 which is connected to the electricity supply line 30, for the continuously adjustable reversible storage of electrical energy. The energy storage unit 28 is configured for the storage and release of electrical energy in an essentially continuously controllable manner. To this end, the energy storage unit 28, in the present case, comprises electrical energy stores which are not represented in greater detail, which energy stores can comprise, for example, capacitors, accumulators, inductances and/or similar. The energy stores are electrically coupled by means of an inverter, which likewise is not represented in greater detail, to the energy supply line 30. The inverter can also be employed as a rectifier, in particular as a controlled rectifier. It is thus possible for the infeed of energy to, or the evacuation of energy from the energy storage unit 28 to the energy supply line 30 to be controlled in a definable manner.

The electrolysis system 10 further comprises a control unit 104, by means of which the functionality of the electrolysis system 10 can be controlled. Inter alia, the control unit 104 delivers a third control signal for the energy storage unit 28, by means of which the energy flux from and to the energy storage unit 28 can be controlled. In particular, by means of the third control signal, the unrepresented inverter, with respect to the functionality and the capacity thereof, can be controlled in a bidirectional orientation.

The control unit 104 further delivers a first control signal for the energy supply unit 40 of the first electrolysis device 36 and a second control signal for the energy supply unit 38 of the second electrolysis device 34. By means of the first and the second control signal, inter alia, electrical capacities of the electrolysis devices 34, 36 can be at least partially controlled.

In an unrepresented manner, the control unit 104 is communicatively connected to a control center of the AC voltage source 32 and is supplied by the latter with data with respect to available capacity which can be employed by the electrolysis system 10.

In the same way, the control unit 104 is connected by means of signals to the energy supply units 38, 40 and to the energy storage unit 28, and receives therefrom, inter alia, signals with respect to the regulation operation of the respective electrolysis devices 34, 36, particularly with respect to a respective electrolysis current flowing through the respective electrolysis modules 12 to 26.

The second energy supply unit 38 comprises a transformer unit 92 which, in turn, comprises two transformers 42, 44. In the present case, the transformers 42, 44 are identically configured for three-phase operation. Each of the transformers 42, 44 comprises a respective primary winding 66, 68 which, in the present case, is delta-connected. The primary windings 66, 68 are electrically connected by means of respective current transformers 114 and a common tap changer 116 to the electricity supply line 30. By means of the tap changer 116, it is possible for taps of the primary windings 66, 68 to be electrically contact-connected and, in this manner, for a step-wise capacity or voltage adjustment to be executed. The transformers 42, 44 are thus configured with a step-wise adjustable design.

The transformer 42 moreover comprises two secondary windings 74, 76, wherein a first of the secondary windings 74 is delta-connected, and a second of the secondary windings 76 is star-connected. A rectifier unit 50 is connected to the secondary winding 74, and a rectifier unit 52 is connected to the secondary winding 76. A corresponding layout applies to the second transformer 44, wherein one secondary winding 78 is connected to a rectifier unit 54 in a delta-connected circuit, whereas a further secondary winding 80 is connected to a rectifier unit 56 in a star-connected circuit.

In the present case, it is provided that the rectifier units 50 to 56 can be controlled by means of the second control signal, in accordance with electrical energy which is available for supply from the energy source 32. To this end, it is provided that the rectifier units 50 to 56 respectively comprise thyristor-based bridge circuits, by means of which a controlled rectification can be executed in accordance with the phase control principle. In the present case, control of the rectifier units 50 to 56 is executed in accordance with the second control signal of the control unit 76.

The rectifier units 50 to 56, at the respective AC voltage sides thereof, are connected to the respective secondary windings 74, 76, 78, 80. A respective DC voltage side of the rectifier units 50, 52, 54, 56 is connected to a respective switching unit 106 which, in the present case, is also configured with an essentially identical design. The switching units 106 comprise a respective current transformer 108 for the acquisition of a direct current of the respective rectifier unit 50, 52, 54, 56. Respective sensor signals of the current transformers 108 are transmitted to the control unit 104. The switching units 106 moreover comprise respective switching elements 110, 112 by means of which the bipolar isolation of electrolysis modules 12, 14, 16, 18 which are connected to the switching units 106 can be executed. It is thus possible, by means of the switching units 106, for the electrolysis modules 12, 14, 16, 18 to be electrically isolated. The switching elements 110, 112, with respect to the circuit state thereof, are also controllable by means of the second control signal of the control unit 104. In the present case, it is provided that the switching elements 110, 112, in each case, essentially assume the same circuit state, in accordance with the second control signal.

The electrolysis device 34, in the present configuration, is thus designed to be controlled in two different manners with respect to the capacity thereof wherein, on the one hand, by means of the tap changer 116, a setting of a respective capacity step can be executed whereas, by means of the preferably essentially continuously controllably operable rectifier units 50, 52, 54, 56, a virtually continuous adjustment of capacity within a predefined capacity step can be executed in accordance with the second control signal.

The first electrolysis device 36 is essentially configured with a substantially identical design to the second electrolysis device 34. The first electrolysis device 36 comprises a transformer unit 94, which unit also comprises two transformers 46, 48, the primary windings 70, 72 of which, by means of respective current transformers 114 and a common tap changer 90, are connected to the energy supply line 30. Here again, the primary windings 46, 48 are delta-connected, whereas a secondary winding 82 of the transformer 46 is likewise delta-connected, and a secondary winding 84 of the transformer 46 is star-connected. In the transformer 48, the primary winding 72 is likewise delta-connected, whereas one secondary winding 86 is delta-connected and one secondary winding 88 is star-connected. The structure of the transformer unit 94 thus corresponds to that of the transformer unit 92. An energy supply unit 40 of the electrolysis device 36 comprises the transformer unit 94.

The energy supply unit 40 further comprises rectifier units 58, 60, 62, 64, wherein the rectifier unit 58, at the AC voltage side thereof, is connected to the secondary winding 82, the rectifier unit 60, at the AC voltage side thereof, is connected to the secondary winding 84, the rectifier unit 62, at the AC side thereof, is connected to the secondary winding 86, and the rectifier unit 64, at the AC voltage side thereof, is connected to the secondary winding 88. The respective DC voltage sides are connected to respective switching units 106 which correspond to the above-mentioned switching units 106, on which grounds any further elaborations with respect thereto are omitted. A series-connected arrangement of six respective electrolysis modules 20, 22, 24, 26 is connected to each of the switching units 106. Accordingly, this structure likewise corresponds to that of the electrolysis device 34.

The electrolysis device 36 is only distinguished from the electrolysis device 34 with respect to the energy supply unit 40 and, in the present case, with respect to the rectifier units 58, 60, 62, 64 which are configured as uncontrolled bridge rectifier circuits, which circuits, in the present case, are embodied by corresponding diodes. The bridge rectifier circuit, in an uncontrolled form, will be known to a person skilled in the art, on which grounds, in the present case, any further elaborations with respect thereto are omitted. Consequently, in the electrolysis device 36, by way of distinction from the electrolysis device 34, a variation of capacity is only possible by means of the tap changer 90. Accordingly, only a step-wise adjustment of capacity is possible.

Here again, with respect to adjustment facilities, the energy supply unit 40 is controllable by means of the first control signal of the control unit 104.

Control signals, namely, the first, second and third control signals of the control unit 104 are correspondingly configured such that the desired control functionalities for the first and second electrolysis units 34, 36, and for the energy storage unit 28, can be embodied. At the same time, corresponding signals can be transmitted by the energy supply units 38, 40, and by the energy storage unit 28, to the control unit 104, such that respective operating states can be ascertained by the control unit 104.

According to the present configuration, it is provided that the tap changer 116, 90 respectively enables an adjustment over ten steps. Although not further represented in the figures, in principle, it is possible that the electrolysis system 10 can further comprise additional electrolysis devices 34 and/or 36.

Design capacities of the individual components and of the electrolysis devices 34, 36 are preferably selected in a correspondingly appropriate manner, such that—as described hereinafter—an essentially continuous capacity adjustment with respect to the AC voltage source can be achieved, with the lowest possible system perturbations. This is further described hereinafter. It is thus possible, not only to reduce technical effort associated with the control of the electrolysis system 10, in comparison with the prior art, but also to reduce the technical effort associated with system perturbations on the AC voltage source 32. This is particularly advantageous, on the grounds that the electrolysis system 10 is generally equipped for comparatively high capacity conversion rates. Although it is intended for a variable capacity take-up of the electrolysis system 10 to be achieved, system perturbations can be substantially reduced with limited technical effort. This means that, particularly in consideration of the high capacity involved, complex filtering measures for system perturbations, for example with respect to harmonics, the power factor, or similar, can be reduced.

In order to enable the supply of the requisite DC current for the electrolysis modules 12 to 26, it is necessary for the corresponding rectifier units 50 to 64 to be supplied with a corresponding AC voltage. In consideration of a variable nature of the impedance of the electrolysis modules 12 to 26 which, for example, can be configured as PEM modules, this supply can be achieved by means of the tap changers 116, 90 of the transformer units 92, 94. At the same time, it must be considered that a respective step setting of the tap changer 116, 90 has a significant influence upon the power factor, which can be established on the energy supply line 30. It is observed that, the lower the selected step on the tap changer, the higher the resulting power factor.

It should also be observed that controlled rectifier units, such as the rectifier units 50 to 56, also influence the power factor. It is observed that, the smaller the ignition angle for thyristors, the higher the resulting power factor. In principle, it has been established that, if the ignition angle is actively adjusted between approximately 6° and approximately 20°, and an appropriately selected step of the tap changer 116, 90 is engaged, the power factor can essentially be of the order of 0.9. For higher values with respect to the power factor, a corresponding power factor correction unit is required, for example comprising a capacitor bank or similar. This correction can also be achieved, for example, by means of the energy storage unit 28. By means of appropriate control measures, the energy storage unit 28 can be employed for raising the power factor.

With respect to AC current harmonics on the energy supply line 30, it can further be established that these are essentially determined by the control of thyristors. In general, a value for AC current total harmonic distortion (THDI) for a 24-pulse system of a respective rectifier unit 50 to 56 is approximately 6%. However, it is conceivable that, even with optimum DC current control, an improvement with respect to harmonics can be achieved by increasing the active power flux to approximately 2-3%, from which a value for distortions of the order of approximately 3% to approximately 4% can proceed. With respect to the majority of AC voltage sources, which are based upon electric power supply grids such as the public electricity supply grid, however, a distortion of less than 2% is required such that, in general, the provision of corresponding filtering measures is required.

By means of the electrolysis system according to FIG. 1, it is possible for the technical effort associated with power factor correction and the filtering of harmonics to be significantly reduced.

FIG. 2 shows a schematic diagrammatic representation of the actuation of one of the tap changers 116, 90 in the form of a curve 96, wherein a respective step of the respective tap changer 116, 90 is plotted on the y-axis, and the time in minutes is plotted on the x-axis. From FIG. 2 it can be seen that, in the exemplary embodiment considered, a step-up by a respective step of 1 is executed at intervals of approximately 0.5 minutes.

FIG. 3, in a further schematic diagrammatic representation, shows how, for a step-change variation of the tap changer 116 of the energy storage unit 28 of this type and/or the control of rectifier units 50 to 56, a virtually continuous rise in the capacity take-up of the electrolysis system 10 can be achieved. This is represented in FIG. 3 by means of the curve 100. The electrical capacity take-up of the electrolysis system in MW is plotted on the y-axis of the diagram according to FIG. 3. The step setting of the tap changer 90 of the electrolysis device 36 is represented by a curve 98.

As described above, the rectifier units 58 to 64 of the rectifier units 58 to 64 of this electrolysis device 36 are not controllable. Consequently, the total capacity take-up of the electrolysis system 10 rises with each step on the tap changer 90, as also represented by the curve 98. As the capacity take-up of the electrolysis system 10 is not permitted to exceed the capacity which is supplied by the AC voltage source 32, according to the curve 100, abrupt capacity variations of the order of 1 MW respectively occur, as can be seen from the diagram according to FIG. 3. However, abrupt capacity variations of this type are not desirable, and can result in substantial distortions. In consequence, it is thus provided that the energy storage unit 28 is operated according to the curve 102. This means that, for an increase in capacity according to the curve 100, only a continuous capacity adjustment according to the curve 102 is necessary by means of the energy storage unit 28, which can be operated continuously. This means that a power factor correction and/or an adjustment with respect to harmonics is only required for a capacity of 0 to 1 MW. Other capacity steps can be executed in a step-wise manner, preferably by means of the electrolysis device 36, which only provides for a step-wise variation. As a result of the uncontrolled rectifier units 58 to 64, the influence on harmonics is essentially negligible. This means that, by means of the energy storage unit 28, a power factor adjustment associated with the step-wise increase in capacity can be executed by means of the tap changer 90 whereas, essentially, the provision of a harmonic filtering function is only necessary for the energy storage unit 28.

According to an alternative scenario, a continuous capacity adjustment is achieved by means of the electrolysis device 34 and the rectifier units 50 to 56 thereof. To this end, ignition angles of the thyristor-based rectifier units 50 to 56 can be correspondingly controlled. In consequence, the provision of an adjustment of the power factor and a filtering of current harmonics is only necessary for the electrolysis device 34.

According to a further configuration, it can be provided that both the energy storage unit 28 and the electrolysis device 34 are employed for continuous step-wise capacity adjustment, in a consequently cooperative arrangement. The advantageous consequence is nevertheless maintained to the effect that, for the entire capacity take-up of the electrolysis system 10, the implementation of corresponding precautionary measures with respect to system perturbations is not required. Accordingly, not only is an economization of technical effort with respect to the electrolysis device 36 observed vis-à-vis the prior art, but also a reduction of technical effort with respect to system perturbations, on the grounds that this effort can be substantially reduced, if not entirely economized, to some extent, for the electrolysis device 36.

Naturally, the invention is not limited to the employment of thyristors or similar in rectifier units but, at least to some extent, transistors, in particular insulated-gate bipolar transistor (IGBT) units and/or similar can also be employed. For the design of the electrolysis system 10, it can further be considered that design capacities for the energy storage unit 28 and/or for the electrolysis devices 34, 36 can be different.

Preferably, these design capacities-depending upon the number of electrolysis devices and/or of energy storage units-are correspondingly selected such that an above-mentioned energy adjustment according to FIG. 3 can be achieved. In particular, it is not necessary for the capacity steps, as represented by the curve 98 according to FIG. 3, to be equal to 1 MW. According to requirements, a capacity can naturally be selected which deviates therefrom.

The invention enables the achievement of a flexible response to varying available capacities on the AC grid system 32, and enables the most optimum possible utilization of energy, wherein technical effort for interference suppression or with respect to system perturbations and the filtering of harmonics can be restricted to a comparatively low level. Additionally, an efficiency of the electrolysis system 10 can be enhanced accordingly.

Exemplary embodiments are intended exclusively for the illustration of the invention, and are not provided by way of limitation.

1-10. (canceled)

11. An electrolysis system for producing hydrogen and oxygen by electrolyzing water, the electrolysis system comprising:
an electrical energy supply line energized by an alternating electric voltage and configured for electrically coupling an electrical energy source;
at least one first electrolysis device and at least one second electrolysis device connected to said electrical energy supply line for supplying said electrolysis devices with electrical energy for a regulation electrolysis operation;
said electrolysis devices each respectively including an energy supply unit and at least one electrolysis module electrically coupled to said energy supply unit;
said at least one electrolysis module including a plurality of electrolysis cells being at least partly electrically series-connected or parallel-connected;
said energy supply units of said electrolysis devices each respectively including at least one transformer and at least one rectifier unit, said at least one rectifier unit having an AC voltage side and a DC voltage side, said DC voltage side of said at least one rectifier unit being electrically connected to said at least one electrolysis module;
said at least one transformer including a primary winding electrically coupled to said energy supply line and a secondary winding connected to said AC voltage side of said at least one rectifier unit;
said primary winding of said at least one transformer of at least said first electrolysis device being configured for step-wise adjustment, and said at least one rectifier unit of said energy supply unit of said first electrolysis device configured to be operated in an uncontrolled manner; and
said at least one rectifier unit of said energy supply unit of at least said second electrolysis device being configured to be operated in a controlled manner, according to an electrical energy able to be supplied by the energy source.

12. The electrolysis system according to claim 11, which further comprises an energy storage unit connected to said energy supply line for a reversible storage of electrical energy, said energy storage unit configured for a continuous storage and release of electrical energy in a controlled manner.

13. The electrolysis system according to claim 12, wherein said energy storage unit has a rated capacity with respect to the storage and release of electrical energy being greater than a capacity differential of two sequential steps of said step-wise adjustable primary winding during the regulation operation of said at least one first electrolysis device.

14. The electrolysis system according to claim 12, which further comprises a control unit configured to receive an energy availability signal and, according to the energy availability signal, to firstly execute a setting of a step of said primary winding of said at least one transformer of said at least one first electrolysis device, and secondly to execute an adjustment of at least an electrical capacity of said at least one second electrolysis device by said rectifier unit of said at least one second electrolysis device, or at least the electrical capacity of said energy storage unit.

15. The electrolysis system according to claim 12, wherein a sum of a rated capacity of said energy storage unit with respect to the storage and release of electrical energy, and a rated capacity of said at least one controllably operable rectifier unit of said energy supply unit of said at least one second electrolysis device is greater than a capacity differential of two sequential steps of said step-wise adjustable primary winding in the regulation operation of said at least one first electrolysis device.

16. The electrolysis device according to claim 11, wherein said at least one transformer for the step-wise adjustment of said primary winding includes a tap changer having between at least five and at least nine steps.

17. An electrolysis system for producing hydrogen and oxygen by electrolyzing water, the electrolysis system comprising:
an electrical energy supply line energized by an alternating electric voltage and configured for electrically coupling an electrical energy source;
at least one first electrolysis device and at least one second electrolysis device connected to said electrical energy supply line for supplying said electrolysis devices with electrical energy for a regulation electrolysis operation;
said electrolysis devices each respectively including an energy supply unit and at least one electrolysis module electrically coupled to said energy supply unit;
said at least one electrolysis module including a plurality of electrolysis cells being at least partly electrically series-connected or parallel-connected;
said energy supply units of said electrolysis devices each respectively including at least one transformer and at least one rectifier unit, said at least one rectifier unit having an AC voltage side and a DC voltage side, said DC voltage side of said at least one rectifier unit being electrically connected to said at least one electrolysis module;
said at least one transformer including a primary winding electrically coupled to said energy supply line and a secondary winding connected to said AC voltage side of said at least one rectifier unit;
an energy storage unit connected to said energy supply line for a reversible storage of electrical energy, said energy storage unit configured for a continuous storage and release of electrical energy in a controlled manner; and
said primary winding of said at least one transformer of at least said first electrolysis device configured to be adjustable in a step-wise manner, and said at least one rectifier unit of said energy supply unit of said first electrolysis device configured to be operated in an uncontrolled manner.

18. The electrolysis system according to claim 17, wherein said at least one rectifier unit of said energy supply unit of at least said second electrolysis device configured to be operated in a controlled manner, according to an electrical energy able to be supplied by the energy source.

19. The electrolysis system according to claim 17, wherein said energy storage unit has a rated capacity with respect to the storage and release of electrical energy being greater than a capacity differential of two sequential steps of said step-wise adjustable primary winding during the regulation operation of said at least one first electrolysis device.

20. The electrolysis system according to claim 17, which further comprises a control unit configured to receive an energy availability signal and, according to the energy availability signal, to firstly execute a setting of a step of said primary winding of said at least one transformer of said at least one first electrolysis device, and secondly to execute an adjustment of at least an electrical capacity of said at least one second electrolysis device by said rectifier unit of said at least one second electrolysis device, or at least the electrical capacity of said energy storage unit.

21. The electrolysis system according to claim 17, wherein a sum of a rated capacity of said energy storage unit with respect to the storage and release of electrical energy, and a rated capacity of said at least one controllably operable rectifier unit of said energy supply unit of said at least one second electrolysis device is greater than a capacity differential of two sequential steps of said step-wise adjustable primary winding in the regulation operation of said at least one first electrolysis device.

22. The electrolysis device according to claim 17, wherein said at least one transformer for the step-wise adjustment of said primary winding includes a tap changer having between at least five and at least nine steps.

23. A method for producing hydrogen and oxygen by electrolysis of water using an electrolysis system, the method comprising:
providing a plurality of electrolysis devices, the electrolysis devices respectively including an energy supply unit and at least one electrolysis module electrically coupled to the energy supply unit, the at least one electrolysis module including a plurality of electrolysis cells being at least partly electrically series-connected or parallel-connected;
using an electrical energy supply line energized by an alternating electric voltage for a regulation electrolysis operation and electrically coupled to an electrical energy source to supply the electrolysis devices with electrical energy;
the energy supply units of the electrolysis devices each respectively including at least one transformer and at least one rectifier unit, the at least one transformer including a primary winding electrically coupled to the energy supply line and a secondary winding connected to an AC voltage side of the at least one rectifier unit, a DC voltage side of the at least one rectifier unit being electrically connected to the at least one electrolysis module;
the primary winding of the at least one transformer of at least a first of the electrolysis devices being configured for step-wise adjustment, and the at least one rectifier unit of the energy supply unit of at least the first electrolysis device being configured to be operated in an uncontrolled manner; and
the at least one rectifier unit of the energy supply unit of at least a second of the electrolysis devices being configured to be operated in a controlled manner, according to an electrical energy able to be supplied by the energy source.

24. A method for producing hydrogen and oxygen by an electrolysis of water using an electrolysis system, the method comprising:
providing a plurality of electrolysis devices, the electrolysis devices respectively including an energy supply unit and at least one electrolysis module electrically coupled to the energy supply unit, the at least one electrolysis module including a plurality of electrolysis cells being at least partly electrically series-connected or parallel-connected;
using an electrical energy supply line energized by an alternating electric voltage for a regulation electrolysis operation and electrically coupled to an electrical energy source to supply the electrolysis devices with electrical energy;
the energy supply units of the electrolysis devices each respectively including at least one transformer and at least one rectifier unit, the at least one transformer including a primary winding electrically coupled to the energy supply line and a secondary winding connected to an AC voltage side of the at least one rectifier unit, a DC voltage side of the at least one rectifier unit being electrically connected to the at least one electrolysis module;
providing an energy storage unit connected to the energy supply line, configured for a reversible storage of electrical energy and configured to execute a storage and release of electrical energy in a continuously controllable manner;
the primary winding of the at least one transformer of at least a first of the electrolysis devices configured for step-wise adjustment, and the at least one rectifier unit of the energy supply unit of at least the first electrolysis device being operated in an uncontrolled manner.
